(19) United States
(12) Patent Application Publication
(10) Pub. No.: US 2008/0079564 A1
(43) Pub. Date: Apr. 3, 2008

(54) Method and system for devices to communicate wirelessly using RFID air protocols

(75) Inventors: Gary Mark Shafer, Boca Raton, FL (US); Mark Alexis, Wellington, FL (US)

Correspondence Address: Christopher & Weisberg, P.A., 200 East Las Olas Boulevard, Suite 2040, Fort Lauderdale, FL, 33301, US

(73) Assignee: Sensormatic Electronics Corporation

(21) Appl. No.: 11/801,232

(22) Filed: May 9, 2007

Related U.S. Application Data
(60) Provisional application No. 60/848,127, filed on Sep. 29, 2006.

(51) Int. Cl. H04Q 7/00; H04Q 5/22

(52) U.S. Cl. 340/539.1; 340/10.1

(57) ABSTRACT

A method and system for exchanging data between one or more RFID readers and one or more non-tag devices in an RFID system using RFID air interface protocol. An RFID system includes one or more non-tag devices in data communication with one or more RFID readers over an interrogation zone. Non-tag devices utilize RFID air interface protocol to transmit and receive wireless data signals to and from the RFID readers, obviating the need to implement a separate communication infrastructure. The RFID readers may forward the data to an RFID backscatter enabled host computer for processing the received signals. Non-tag devices acting as readpoints communicate with other non-tag devices to establish a parent/child readpoint hierarchy. One or more multiplexers may facilitate the data exchange between RFID readers and the non-tag devices in order to provide an even more robust communication network.

### CROSS-REFERENCE TO RELATED APPLICATION

This application is related to and claims priority to U.S. Provisional Patent Application Ser. No. 60/848,127, filed Sep. 29, 2006, entitled US Provisional Patent for METHOD AND SYSTEM FOR DEVICES TO COMMUNICATE WIRELESSLY USING RFID AIR PROTOCOLS, the entirety of which is incorporated herein by reference.

### STATEMENT REGARDING FEDERALLY SPONSORED RESEARCH OR DEVELOPMENT

n/a

### FIELD OF THE INVENTION

The present invention relates to radiofrequency identification (“RFID”) communications, and in particular to an RFID network that uses an air interface protocol to support devices other than RFID tags.

### BACKGROUND OF THE INVENTION

RFID systems are used in many different applications including for example, in retail environments to obtain information relating to items tagged with RFID identifiers. For example, an RFID tag can be attached or integrated within a product or product packaging. Using an RFID interrogator (also referred to herein as an “RFID reader”), which may be a fixed, portable or handheld device, RFID tags within the interrogation zone of the interrogator may be activated and provide information regarding the item associated with the RFID tag (e.g., product descriptor, serial number, location, etc.). These RFID tags receive and respond to radio frequency (“RF”) signals to provide information, for example, related to the product to which the RFID tag is attached. This is typically accomplished using a standard air interface protocol such as the Electronic Product Code (“EPC”) Radio Frequency Identity Protocol. Such information may include inventory information relating to items on a shelf or items in a warehouse. In general, modulators within the RFID tags may transmit back a signal using a transmitter or reflect back a signal to the RFID readers. This transmitted/reflected signal is referred to as a backscatter signal. Additionally, information may be communicated to the RFID tags (e.g., encoding information) using RFID encoders. Thus, RFID systems are typically used to monitor the inventory of products in a retail environment and provide product identification using the storage and remote retrieval of data using RFID tags or transponders.

In addition, certain RFID applications use a reader to connect to multiple antennas through a multiplexer (“MUX”). For example, in a retail environment using an RFID system to track inventory, it is known to provide numerous read points that each include the use of RF multiplexers and numerous cables to connect to each read point. In this context, the MUX routs RFID signals, i.e., RF signals, to multiple antennas based on digital logic inputs from a controller. The MUX and the antennas coupled to the MUX are typically used to extend the range of a reader to be able to send commands and/or data to tags and to receive backscatter signals containing responses and/or data from the tags. One example is an RFID network in which RFID tagged merchandise is placed on shelves having multiple antennas all connected to a central reader. Such a network provides a long term inventory of items on the shelves. However, in such a network having multiple antennas, numerous wires and cables must be connected to the MUX in order to route the control, RF signals and alternating current/direct current (AC/DC) power necessary for network functionality. Also, MUXes that are coupled to MUXes in a nested arrangement to extend the range of the RFID reader can quickly lead to a scenario in which the relationship between the MUXes and antennas gets complex and difficult to track and understand. It is desirable to have a method and system that easily allows the relationship between the MUXes to be mapped and understood.

The cost and complexity of these RFID systems is typically high. Further, the time and complexity to install the components also may be high, for example, when having to install bulky cable harnesses, etc. Using multiple RFID interrogators in such systems to monitor RFID tags in different locations further adds to the cost of installing and maintaining the system. The result is that RFID customers invest a lot of money to install and maintain RFID network systems that are principally used for inventory management.

These same customers also have a need for other communications. For example a customer who has an RFID system for inventory management may also have a security monitoring system, or at least have a need for one. This typically requires an installation of cameras, photo-infrared detectors, sensors, etc., that must be wired communicate by a wireless communication system with a monitoring station or alarm panel. This communication infrastructure is separate from the infrastructure used for the RFID system. It is desirable to have a method and system that allows the sharing of the RFID infrastructure for non-RFID tag communication uses.

### SUMMARY OF THE INVENTION

The present invention advantageously provides a method and system for communication between one or more RFID readers and one or more non-tag devices in an RFID network using RFID interface protocol. The method and system disclosed herein uses the radio frequency spectrum and RFID communication protocol to allow data communication between an RFID reader and one or more non-RFID tag devices. Non-tagged items, such as, for example, multiplexers, cameras, shelf readers, alert devices, or computers, appear as RFID-tags to the RFID reader, even though the data exchanged is not tag-related data. Thus, network communications between RFID readers and non-tagged items can occur without the need for additional installation and/over overhead costs.

In one embodiment, a method for using an RFID system to support data communications with non-tag devices is provided. The method includes using an RFID air interface protocol to communicate with one or more non-tag devices.

In another embodiment, an RFID system is provided. The system includes one or more RFID readers in data communication with one or more non-tag devices, where each RFID reader has a communication range. The one or more RFID readers communicate with the non-tag devices via RFID air interface protocol.

In still another embodiment, the present invention provides an RFID multiplexer. The RFID multiplexer includes a processing unit controlling the operation of multiplexer. The processing unit operates to interrogate one or more non-tag devices to obtain data. A storage unit stores the data relating to the non-tag devices.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein like designations refer to like elements, and wherein:

FIG. 1 is a block diagram of a system constructed in accordance with the principles of the present invention;

FIG. 2 is a block diagram of an RFIP multiplexer constructed in accordance with the principles of the present invention;

FIG. 3 is a block diagram of an alternate embodiment of the present invention; and

FIG. 4 is a block diagram illustrating a hierarchal arrangement of readpoint devices in accordance with the present invention.

### DETAILED DESCRIPTION OF THE INVENTION

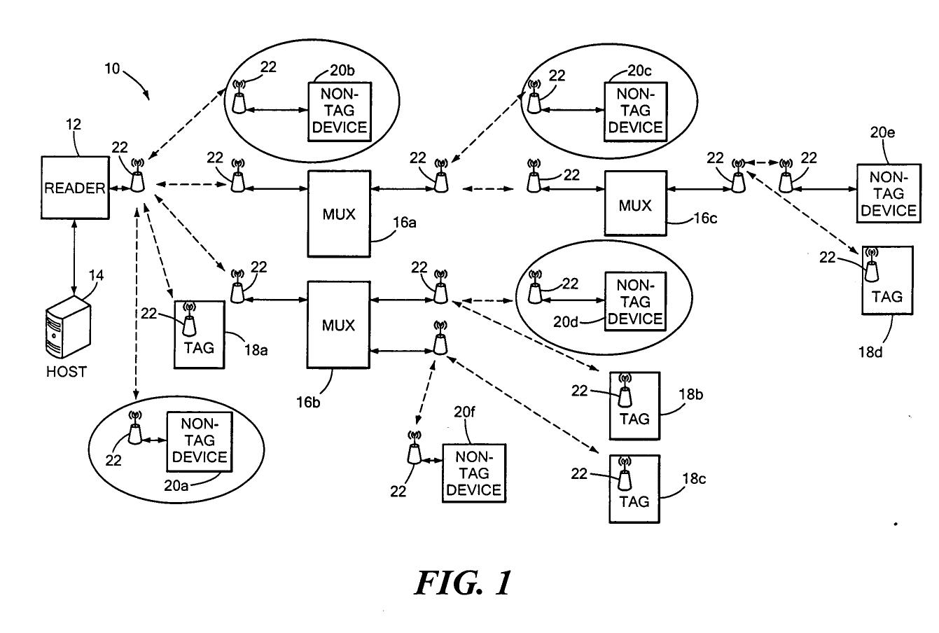

Referring now to the drawing figures in which like reference designators refer to like elements, there is shown in FIG. 1 a diagram of an exemplary system constructed in accordance with the principles of the present invention and designated generally as “10”. System 10 includes one or more readers 12 in communication with a host computer 14. Reader 12 exchanges data with computer 14 as may be necessary, e.g., to perform inventory control. In this case host computer 14 includes the databases used to track and maintain the inventory. Host computer 14, as described below, also includes those components, e.g., memory, CPU, I/O, display, etc., to track the communication and hierarchical relationship between the other devices in system 10, e.g., MUXes, tags, non-tag devices, and the like. This allows an operator to understand how the components are interconnected and also allows system components, to be used with specificity, e.g., updating pricing on a shelf reader visual display associated with a particular type of item or even receiving image data from a particular camera if a particular sensor is tripped.

System 10 includes MUXes 16a-c (referred to collectively herein as “MUXes 16”), traditional RFID tags 18a-d (referred to collectively herein as “tags 18”) and non-tag devices 20a-f (referred to collectively herein as “non-tag devices 20”). Of note, the quantities of MUXes 16, tags 18 and non-tag devices 20 shown in FIG. 1 is purely exemplary and a system 10 can include differing amounts, if any, of a particular one of these elements. The reader 12, MUXes 16, tags 18 and non-tag devices 20 communicate wirelessly with one another using antennas 22 via backscatter. Of note, although some elements, such as tags 18, show antenna 22 within the device, this arrangement is merely exemplary. It is contemplated that an antenna 22 can be incorporated within, or externally coupled to the reader 12, MUXes 16, tags 18 and non-tag devices 20.

Of note, although FIG. 1 shows that all devices are in direct or indirect wireless communication with reader 12, the present invention is not limited to such. It is contemplated that one or more devices, e.g., a MUX 16, can be connected to reader 12 in a wired fashion.

This present invention advantageously allows a variety of data to be sent wirelessly by extending an existing RFID air interface protocol such as the Electronic Product Code (“EPC”) Radio Frequency Identity Protocols. The method and system of the present invention use the radio frequency spectrum and protocol transmitted to/from RFID interrogator 12 (note that the terms “reader” and “interrogator” are used interchangeably herein) as the medium for network communication. The communicating devices use the standard protocols to transmit, receive and decode the RFID packets, but the data within the packets need not simply be data and commands related to tag identification and control. Put another way, MUXes 16 and non-tag devices 20 appear to the RFID readers, transmitters and receivers as tags 18, even though the data and/or commands relating to the MUXes 16 and non-tag devices 20 is not tag-related data. This extends traditional tag identifying/writing/reading to allow more robust communications with RFID multiplexers 16 and other non-tag devices 20. This also advantageously eliminates or reduces cabling and installation costs normally required for the interconnection of RFID readpoints and other devices (motion detectors, EAS systems, cameras, door alarms, intrusion alarms).

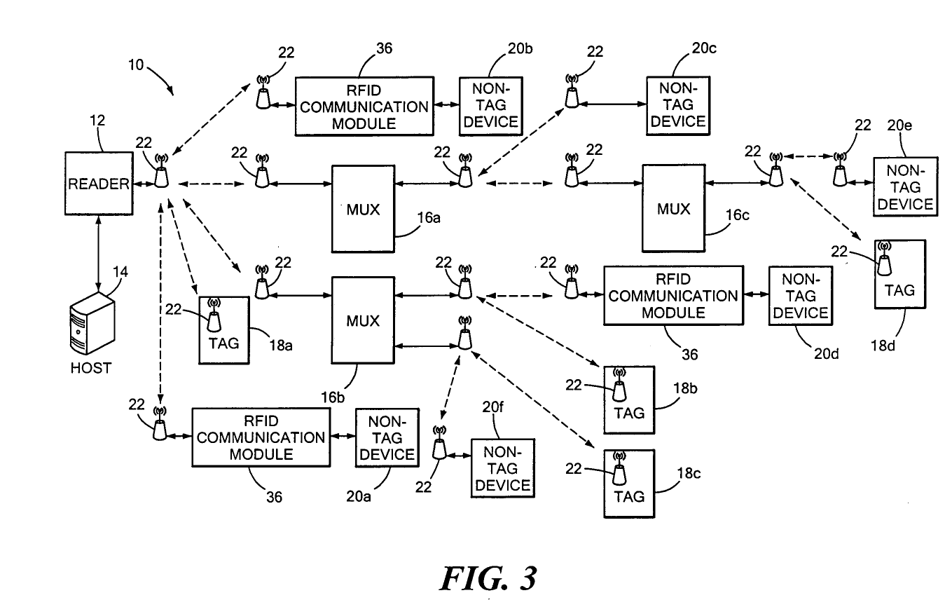

In accordance with the present invention, non-tag devices 20 can be any device requiring networked communication. For example, non-tag devices 20 may include but are not limited to, cameras, shelf readers, computers, PIRs, alarms, visual or audio alert devices and systems, controllers, etc. Being more specific, non-tag device 20c might be a camera capturing image data and non-tag device 20b may be a computer that needs to receive, process and display the image data and/or control the operation of the camera. If the non-tag device 20 is not natively equipped with the capability to support RFID communications, i.e., backscatter, it is contemplated that a separate unit (shown in FIG. 3 and discussed below) can serve as the interface between the non-tag device 20 and antenna 22 that supports RFID backscatter communications as described herein. For example, the separate unit may use a USB or other serial or parallel communications link to interface with the non-tag device 20. The separate unit can then create and store/buffer the data blocks and respond to RFID interrogation signals.

In accordance with another aspect, a MUX 16 used to inventory tags 18 within its interrogation zone may need to store and forward that inventory information back to host 14 via reader 12. In such a case, MUX 16 includes elements needed to act as a readpoint (it is noted that other non-tag devices 20 can also include reader elements to act as RFID read points) to store and forward tag or non-tag device information.

For example, MUX 16c can be used to detect and read tag data from tags 18 and non-tag devices 20, in its interrogation zone, e.g., tag 18d and non-tag device 20e. Data corresponding to tag 18d is stored in MUX 16c. In turn, MUX 16c appears as a tag to MUX 16a. When MUX 16a interrogates its zone to identify tags 18, MUX 16c appears as tag and its stored inventory list of tags and other devices in its interrogation zone can be sent as one or more data blocks to and stored by MUX 16a. Finally, when main reader 12 interrogates devices in its interrogation zone, MUX 16a appears as a tag. When interrogated further, main reader 12 learns not only of MUX 16a and any tags and non-tag devices in its interrogation zone, but also of MUX 16c and any tags, e.g., tag 18d, and non-tag devices, e.g., non-tag deice 20e, in its interrogation zone. In this manner, reader 12 can supply host 14 with data that can be used to construct a logical relationship between the MUXes 16 to understand how the network is laid out and understand what devices may be in communication with each MUX 16, e.g., a camera, alarm unit, shelf reader, etc.

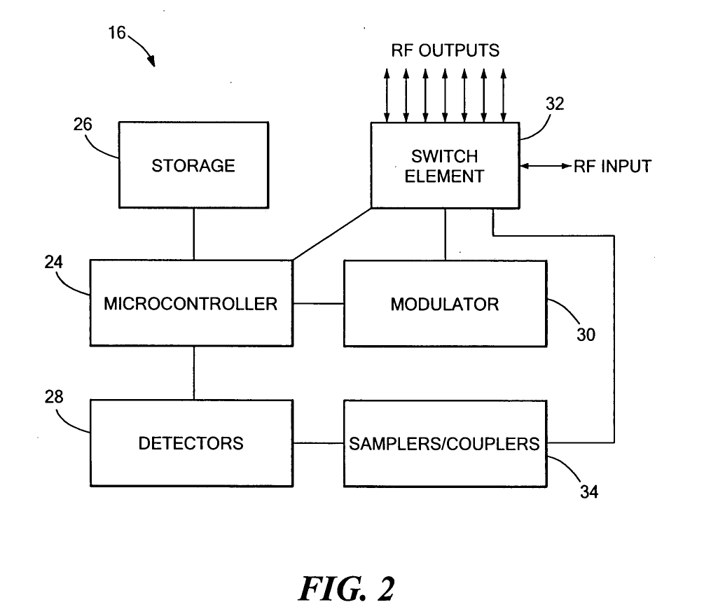

FIG. 2 is a block diagram of an exemplary MUX 16 constructed in accordance with the principles of the present invention as may be used to support the functions described herein. MUX 16 includes microcontroller 24 used to control the operation of MUX 16. Storage unit 26, RF detectors 28, RF modulator 30 and switch element 32 are in electrical communication with microcontroller 24. Samplers and couplers 34 that may be needed are in electrical communication with one or more of the detectors 28. In operation, MUX operating code and data are stored in storage device 26 which can include volatile and/or non-volatile storage areas. Modulator 30 is used to modulate a baseband signal onto an RF carrier for transmission via switch element 32. Detectors 28 and samplers/couplers 34 operate together to detect and extract the baseband signal and command and block data from a received RF signal, such as a signal complying with the EPC air interface standard. Switch element 32 is controlled by microcontroller 24 to switch the input to one of the output lines. Of note, although FIG. 2 shows a microcontroller controlled MUX 16, it is contemplated that the switch element 32 can be controlled by a less intelligent logic circuit.

Referring again to FIG. 1, although FIG. 1 includes MUXes 16, it is not required that all communications between devices, e.g., non-tag devices 20 occur through a MUX 16. It is contemplated that reader 12 can act as a communication bridge between devices, e.g., non-tag device 20a and non-tag device 20b.

Referring to FIG. 3, an alternate embodiment of the present invention is illustrated. If non-tag device 20 is not equipped with the capability to support RFID communications, i.e., backscatter, a separate RFID communication module 36 provides an interface between non-tag device 20 and antenna 22 in order to support RFID backscatter communications. RFID communications module 36 can link non-tag device 20 with reader 12 via a USB or other serial or parallel communications link. RFID communication module 36 has the capability to create, store and/or buffer data blocks received from non-tag devices 20 and to respond to RFID interrogation signals.

As a first non-limiting example, the system and method of the present invention can facilitate transfer of image data from a camera to a host computer. Such may be useful in the case of a camera (as a non-tag device 20) used in conjunction with a security system that is deployed in an environment that also supports an RFID system, e.g., a warehouse, retail store, etc. In this case, two backscatter devices (the camera and the host computer receiving the image data) can share the image data via by using an RFID interrogator (reader 12 or via one or more MUXes 16) as an access point. For example, a backscatter enabled camera encapsulates an image data block. The RFID reader 12 then reads this data block using the RFID air interface protocol. In other words, the camera appears to the RFID reader as just another tag such that the RFID reader is reading the backscatter signal having data from the camera.

The RFID reader in turn writes the data block received from the camera to an RFID backscatter enabled host computer that can take further action with the display data such as display or store the image. As such, in this case, the RFID reader 12 (or MUX 16) acts as a network access point for the camera and the host computer.

Another exemplary implementation of the present invention is in conjunction with a shelf reader system. In this implementation, a wireless system of autonomous shelf readers, e.g., battery powered shelf readers, that collect and forward inventory data and other data, such as status and event data, can be networked. In addition, the shelf system can include the ability to provide data using the RFID air interface protocol to devices to update and show pricing data.

In this embodiment, image data can be forwarded from a readpoint, i.e. from cameras, to the host system such as is described above. In addition, event data can be sent to the host system, e.g., motion alarm event data, collected from and originating from backscatter enabled (RFID air interface protocol enabled) devices within range of each shelf read point (RFID enabled communication device) or the readpoint itself. Individual shelf readpoints can collect, store and forward their inventory data through the RFID network to a central host. This allows distant readpoints to forward data to a central host over the RFID air protocol. The host can download pricing, promotional information, advertising content, etc., to the shelf readpoint for display to customers at the shelf location using the RFID air interface protocol.

It is also contemplated that the customer can execute a query or search of the store inventory at a computing device such as a computer terminal, personal computer, handheld computing device, etc. This information can be sent to a host computer which in turn can download alert information to the shelf readpoint using the RFID air interface protocol. The alert information can include instructions to cause the shelf readpoint to turn on a visible, audible, or other indicator allowing the customer to quickly find the desired item on the store shelf.

The present invention provides a method of encapsulating data items in a serial format (such as XML). The present invention also provides a method of relating RFID readpoints and backscatter devices within range, e.g., a parent readpoint and child backscatter device. In accordance with one aspect of the present invention, readpoints are arranged in a hierarchical arrangement of parent/child readpoints. Another aspect of the present invention provides a method for using a parent readpoint to collect data from child readpoints, storing this data, and then forwarding this data higher in the network.

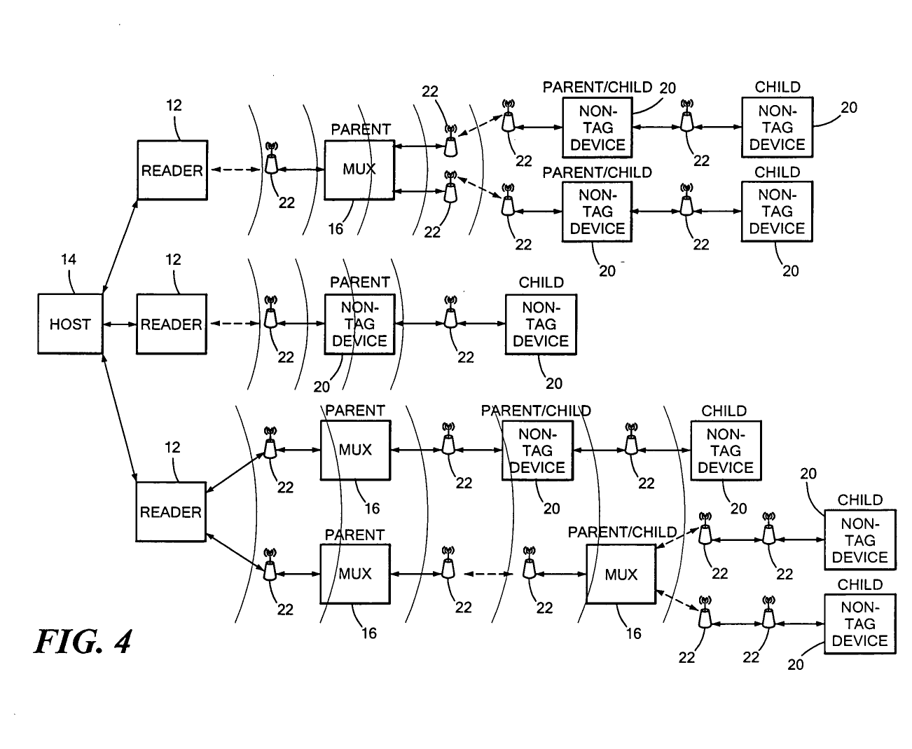

A method for a host system to write data blocks to readpoints and backscatter devices within the network is also provided. FIG. 4 provides an illustration of an embodiment of the invention whereby non-tag devices 20 and MUXes 16 are arranged in a parent-child hierarchy. The present inventions provides a method for discovering all backscatter and readpoint devices within a desired physical location even though many of these devices may be beyond the range of the RFID readers attached to a host. For example, in FIG. 4, a number of non-tag devices 20 are in communication with other non-tag devices 20 and/or MUXes 16. Each communication link represents a parent/child relationship whereby a device (non-tag device 20 or MUX 16) may communicate with another device, higher up in the communication “chain”. This hierarchal relationship enables some non-tag devices 20, normally outside the interrogation zone of an RFID reader 12, to receive RFID interrogation instructions from an RFID reader. The present invention also provides a method for assigning and setting parent-child relationships such as the ones shown in FIG. 4, within the network 10 via host 14.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A communication method, the method comprising:
using an RFID air interface protocol to communicate with one or more non-tag devices.

2. The method of claim 1, further comprising forwarding data from the one or more non-tag devices to an RFID backscatter enabled host computer.

3. The method of claim 1, further providing one or more RFID readers in data communication with the one or more non-tag devices, the one or more RFID readers each having a corresponding interrogation zone, wherein the one or more non-tag devices appear to the one or more RFID readers as RFID tags.

4. The method of claim 3, further comprising providing one or more multiplexers to facilitate data communication between the one or more RFID readers and the one or more non-tag devices.

5. The method of claim 4, wherein the one or more multiplexers contain data interrogation elements for reading data received from the one or more non-tag devices.

6. The method of claim 3, further comprising providing an RFID communication module to facilitate RFID air interface protocol communication between the non-tag devices and the one or more RFID readers.

7. The method of claim 2, wherein at least one of the one or more non-tag devices is a parent readpoint device, the method further comprising transmitting information from the RFID backscatter enabled host computer to the parent readpoint device using the RFID air interface protocol.

8. The method of claim 7, further comprising providing a child readpoint device, the parent readpoint device collecting data from the child readpoint device to create a hierarchical arrangement of parent/child readpoint devices for further data transmission.

9. The method of claim 8, wherein the host computer writes data to the readpoint devices according to the hierarchical arrangement.

10. The method of claim 8, wherein at least one readpoint device is outside the interrogation zone of the one or more RFID readers.

11. The method of claim 2, wherein at least one non-tag device is a camera.

12. The method of claim 11, further comprising:
capturing an image;
storing the image as a data block, and detecting backscatter signals using the air interface protocol, the backscatter signals including the data block.

13. The method of claim 12, further comprising writing the data block to the RFID backscatter enabled host computer.

14. An RFID system comprising:
one or more RFID readers in data communication with one or more non-tag devices, each RFID reader having an interrogation zone, wherein the one or more RFID readers communicate with the non-tag devices via an RFID air interface protocol.

15. The system of claim 14, further comprising an RFID backscatter enabled host computer in data communication with the one or more RFID readers.

16. The system of claim 14, further comprising one or more multiplexers to facilitate data communication between the one or more RFID readers and the one or more non-tag devices.

17. The system of claim 16, wherein the one or more multiplexers contain data interrogation elements for reading data received from the one or more non-tag devices.

18. The system of claim 14, further comprising an RFID communication module to facilitate RFID air interface protocol communication between the non-tag devices and the one or more RFID readers.

19. The system of claim 15, wherein at least one of the one or more non-tag devices is a parent readpoint device capable of receiving information from the host computer using the RFID air interface protocol.

20. The system of claim 19, further comprising one or more child readpoint devices, the parent readpoint devices collecting data from the one or more readpoint devices creating a hierarchical arrangement of parent/child readpoint devices for further data transmission.

21. The system of claim 20, wherein the host computer writes data to the readpoint devices in the RFID system according to the hierarchical arrangement.

22. The system of claim 20, wherein at least one readpoint device is outside the interrogation zone of the one or more RFID readers.

23. The system of claim 15, wherein at least one non-tag device is a camera.

24. The system of claim 23, wherein the camera captures an image and stores the image as a data block, and wherein the RFID reader detects backscatter signals from the camera data block using the air interface protocol, the backscatter signals including the data block.

25. An RFID multiplexer, comprising:
a processing unit controlling the operation of multiplexer, the processing unit operating to interrogate one or more non-tag devices to obtain data; and
a storage unit for storing the data relating to the non-tag devices.
